(19) United States
(12) Patent Application Publication
(10) Pub. No.: US 2013/0315197 A1
(43) Pub. Date: Nov. 28, 2013

(54) METHOD FOR TRANSMITTING AND METHOD FOR RECEIVING A CHANNEL STATE INFORMATION REFERENCE SIGNAL IN A DISTRIBUTED MULTI-NODE SYSTEM

(71) Applicants: Sungho Park, Anyang (KR); Jinyoung Chun, Anyang (KR); Kitae Kim, Anyang (KR)

(72) Inventors: Sungho Park, Anyang (KR); Jinyoung Chun, Anyang (KR); Kitae Kim, Anyang (KR)

(73) Assignee: LG ELECTRONICS INC., Seoul (KR)

(21) Appl. No.: 13/993,498

(22) PCT Filed: Dec. 13, 2011
(86) PCT No.: PCT/KR2011/009573

§ 371 Date: Jul. 17, 2013

Related U.S. Application Data
(60) Provisional application No. 61/423,059, filed on Dec. 14, 2010.

(51) Int. Cl. H04W 72/04

(52) U.S. Cl. CPC H04W 72/042
USPC 370/329

(57) ABSTRACT

The present invention relates to a method for transmitting a reference signal (RS) in a distributed multi-node system. The transmission method comprises: a step of constructing multiple channel state information reference signals (CSI-RSs) having power which is not zero in an intra-cell; and a step in which a base station transmits control information on the multiple CSI-RSs to a terminal. Here, the channel state information reference signals of multiple patterns may be transmitted in one subframe. The transmission method may further comprise a step of receiving feedback information on the channel state information reference signals from the terminal.

### TECHNICAL FIELD

The present specification relates to a distributed multi-node system, and more particularly, to a channel measurement for a node (or an antenna node) and a method of determining a valid node.

### BACKGROUND ART

Since a machine-to-machine (M2M) communication and such various devices requiring high data throughput as a smartphone, a tablet PC, and the like have emerged and are disseminated in a current wireless communication environment, data demand for a cellular network is rapidly increasing.

In order to keep up with the high data demand, a communication technology has been developed with a carrier aggregation technology designed to efficiently use far more frequency bands, a cognitive radio technology, a multi antenna technology designed to increase data capacity in a limited frequency, a multi base station cooperation technology, and the like. And, the communication environment is evolved to a direction that density of a node, which is accessible in the vicinity of a user, becomes higher.

A system equipped with a node of high density may show higher system performance due to cooperation between nodes. This kind of scheme may have a superior performance compared to a case that each node does not cooperate with each other in a manner of operating as an independent base station (e.g., a base station (BS), an advanced BS (ABS), a Node-B (NB), an eNode-B (eNB), an access point (AP), and the like).

### DISCLOSURE OF THE INVENTION

### Technical Tasks

In case of a legacy system (LTE-A Rel-10 or a previous system of the LTE-A Rel-10), although a node controlled by a base station or a cell includes at least one antenna elements, the node is regionally situated at a same location. Hence, the number of node identified by a user equipment for the base station or the cell corresponds to one. Distinction between the base station and the cell and an operation therefor are required, whereas a separate distinction between nodes and an operation therefor are not required.

Yet, in case of a distributed multi-node system, since the distributed multi-node system may have plenty of nodes, a definition for a method of distinguishing each of the nodes and operations according to the definition are required.

In the legacy LTE-A Rel-10 system, a CSI-RS may be able to simultaneously transmit a reference signal for maximum 8 ports. This indicates that a user equipment is able to distinguish up to the maximum of 8 nodes per each cell and may be able to transmit and receive data for maximum 8 layers in a distributed multi-node system.

Yet, if the number of node in a cell is greater than 8, it brings about such a result restricting performance of the distributed multi-node system as a relatively low cell throughput, inefficient interference coordination in a cell edge, or the like.

Although a CSI-RS of LTE-A Rel-10 system is able to transmit a CSI-RS via a multiple subframe offset for 5 duty cycles, a limited subframe configuration in a corresponding duty cycle (for instance, in case of a 5 ms duty cycle, 5 subframes=8 nodes (or 8 antenna elements)*5=40 nodes (or 40 antenna elements)) may lack resolution for a node or antenna element resolution for a whole node in case that a plurality of nodes are arranged in a distributed multi-node system.

Hence, the present specification intends to provide a method of transmitting a plurality of CSI-RS configurations and the CSI-RS to distinguish at least one node in a distributed multi-node system.

And, the present specification intends to provide a method of transmitting control information to distinguish at least one antenna node in a distributed multi-node system.

### Technical Solution

The present specification provides a method of transmitting a reference signal (RS) in a distributed multi-node system. The method of transmitting a reference signal (RS) in a distributed multi-node system includes the steps of constructing multiple channel state information reference signals (CSI-RSs) having power which is not zero in an intra-cell for the distributed multi-node system and transmitting control information on the multiple channel state information reference signals (CSI-RSs), which is transmitted by a base station, to a user equipment (UE).

In this case, the channel state information reference signal of multiple patterns is transmitted to the UE in one subframe. The method of transmitting may further include the step of receiving a feedback information on at least one of the channel state information reference signal from the UE.

Alternatively, the channel state information reference signals of multiple patterns can be transmitted throughout many subframes.

The channel state information reference signals of multiple patterns may include a predetermined duty cycle according to each pattern or according to the multiple patterns. And, the channel state information reference signal in each subframe among the many subframes may include a predetermined offset interval.

The control information may further include information on the maximum number of the CSI-RS capable of being included in one subframe.

At least one of the multiple channel state information reference signals is UE-dedicated or UE-specific. At least one of the multiple channel state information reference signals is cell-specific or UE-common.

The control information may include a CSI-RS type indication information indicating whether the CSI-RS is for a channel state information (CSI) feedback or a node selection feedback.

Feedback information on the node selection may include at least one of RSSI, RSRP, or RSRQ measured for the CSI-RS.

Each of the CSI-RSs consists of each sequence and the each sequence is distinguished by a node index, a port number, or a virtual cell ID.

The sequence of each CSI-RS can be generated in a manner of using a value delivered via a message of an upper layer instead of a physical cell identity.

The virtual cell ID consists of integers greater than or equal to 0 and less than or equal to 503.

The control information may further include information on the maximum number of the CSI-RS capable of being included in one subframe. The intra-cell corresponds to one cell including one physical cell identity or physical layer cell identity.

Meanwhile, the present specification provides a method of receiving a reference signal (RS) in a distributed multi-node system. The method of receiving a reference signal (RS) in a distributed multi-node system include the steps of receiving a control information on a channel state information reference signal (CSI-RS) having power which is not zero from a base station, receiving at least one of the channel state information reference signal from at least one antenna node in an intra-cell based on the control information, and transmitting a feedback information on the at least one of the channel state information reference signal, wherein the control information includes information that the channel state information reference signal (CSI-RS) consists of multiple patterns for the distributed multi-node system.

The channel state information reference signal of multiple patterns can be received in at least one subframe.

Alternatively, the channel state information reference signal of multiple patterns can be transmitted throughout many subframes. Or, the channel state information reference signal of multiple patterns can be received in a manner of being distributed to many subframes. In this case, the channel state information reference signals of multiple patterns may include a predetermined duty cycle according to each pattern or according to the multiple patterns. And, the channel state information reference signal in each subframe among the many subframes may include a predetermined offset interval.

The feedback information may include the feedback information on a channel state information (CSI) or the feedback information on a node.

The feedback information on the node may include at least one of RSSI, RSRP, or RSRQ.

CSI-RS type indication information indicating whether the CSI-RS is for a feedback on the channel state information or the feedback on the node can be received from the base station.

Each of the CSI-RSs consists of each sequence and the each sequence is distinguished by a node index, a port number, or a virtual cell ID.

The channel state information or the node information can be feedback on each of the at least one node or on a combination of the at least one node.

The control information may further include information on the maximum number of the CSI-RS pattern capable of being included in one subframe.

The control information may further include a UE-specific CSI-RS pattern mapping information.

Meanwhile, the present specification provides a transmission station transmitting a reference signal (RS) in a distributed multi-node system. The transmission station includes a control unit configured to construct multiple channel state information reference signals (CSI-RSs) having power which is not zero in an intra-cell and a transmission/reception unit configured to transmit control information on the multiple channel state information reference signals (CSI-RSs) to a user equipment (UE) according to a control of the control unit. In this case, the channel state information reference signal of multiple patterns is transmitted in one subframe. And, the transmission/reception unit is configured to receive feedback information on at least one of the channel state information reference signal from the user equipment.

Meanwhile, the present specification provides a user equipment receiving a reference signal (RS) in a distributed multi-node system.

The user equipment includes a control unit, a reception unit configured to receive control information on the multiple channel state information reference signals (CSI-RSs) having power which is not zero from a base station according to a control of the control unit, and a transmission unit configured to transmit a feedback information on at least one of the channel state information reference signal according to a control of the control unit, wherein the control information includes information on multiple pattern configurations for the channel state information reference signal (CSI-RS), wherein the reception unit configured to receive channel state information reference signal from at least one antenna node in an intra-cell based on the control information, and wherein the channel state information of multiple patterns can be received in one subframe.

### Advantageous Effects

According to the present specification, by defining a CSI-RS including a plurality of configurations and having power, which is not zero, a distributed multi node system including a plurality of nodes may be able to have high cell throughput and may be able to perform efficient interference coordination in a cell edge.

According to the present specification, by transmitting a CSI-RS designed to detect a node, implementation complexity resulted from detecting a node by a user equipment can be reduced.

According to the present specification, by transmitting control information designed to determine a valid antenna, an overhead resulted from time and calculation taken from determining a valid antenna per each antenna node of a user equipment or a base station can be reduced.

### DESCRIPTION OF DRAWINGS

FIG. 1 and FIG. 2 are conceptual diagrams of a distributed multi-node system according to one embodiment of the present specification;

FIG. 3 is a flowchart of a method of transmitting a CSI-RS according to one embodiment of the present specification;

FIG. 4 is a flowchart of a process for transmitting and receiving data between a base station and a user equipment in a DMNS (distributed multi-node system);

FIG. 5 is an internal block diagram of a user equipment and a base station according to one embodiment of the present specification.

### BEST MODE

### Mode for Invention

In the following description, embodiments according to the present specification are explained in detail with reference to the attached drawings. In the following description, only the part necessary to understand the operation according to the present specification is explained and it should be cautious that the explanation on the other part is omitted to prevent the point of the present specification from getting vaguer.

The following embodiments correspond to combinations of elements and features of the present specification in prescribed forms. And, the respective elements or features may be considered as selective unless they are explicitly mentioned. Each of the elements or features can be implemented in a form failing to be combined with other elements or features. Moreover, it is able to implement an embodiment of the present specification by combining elements and/or features together in part. A sequence of operations explained for each embodiment of the present specification can be modified. Some configurations or features of one embodiment can be included in another embodiment or can be substituted for corresponding configurations or features of another embodiment.

In this specification, embodiments of the present specification are described centering on the data transmission/reception relations between a user equipment and a base station. In this case, the base station means as a terminal node of a network performing a direct communication with the user equipment. In this disclosure, a specific operation explained as performed by a base station may be performed by an upper node of the base station in some cases.

In particular, in a network constructed with a plurality of network nodes including a base station, it is apparent that various operations performed for communication with a user equipment can be performed by a base station or other networks except the base station. ‘base station’ may be substituted with such a terminology as a fixed station, a Node B, an eNode B (eNB), an access point (AP) and the like. And, a terminal may be substituted with such a terminology as a user equipment (UE), a mobile station (MS), a mobile subscriber station (MSS), and the like.

Embodiments of the present specification can be implemented using various means. For instance, embodiments of the present specification can be implemented using hardware, firmware, software and/or any combinations thereof.

In case of the implementation by hardware, a method according to each embodiment of the present specification can be implemented by at least one selected from the group consisting of ASICs (application specific integrated circuits), DSPs (digital signal processors), DSPDs (digital signal processing devices), PLDs (programmable logic devices), FPGAs (field programmable gate arrays), processor, controller, microcontroller, microprocessor and the like.

In case of the implementation by firmware or software, a method according to each embodiment of the present specification can be implemented by modules, procedures, and/or functions for performing the above-explained functions or operations. Software code is stored in a memory unit and is then drivable by a processor. The memory unit is provided within or outside the processor to exchange data with the processor through the various means known in public.

Specific terminologies used in the following description are provided to help understand the present specification and the use of the specific terminologies can be modified to a different form within a scope of a technical idea of the present specification.

In the following description, a distributed multi-node system (hereinafter abbreviate DMNS) is briefly explained.

Distributed Multi-Node System: DMNS

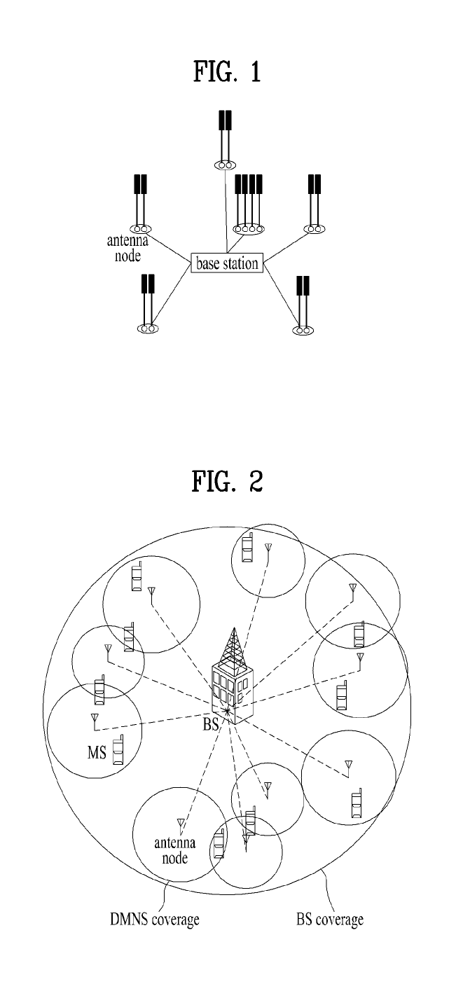

FIG. 1 and FIG. 2 are conceptual diagrams of a distributed multi-node system according to one embodiment of the present specification.

As shown in FIG. 1 and FIG. 2, a DMNS can be consisted of a base station and at least one antenna node.

Unlike a centralized antenna system (CAS) of which antennas of a base station are concentrated in a center of a cell, a DMNS means a system managing antenna nodes (or node), which are distributed in various locations in a cell, by a single base station.

An antenna node is connected to a base station in wired or wirelessly and may be able to include at least one antenna. In general, antennas included in one antenna node have a property that the antennas belong to a regionally same spot, which means a distance to a nearest antenna is less than a couple of meters. The antenna node functions as an access point to which a user equipment can access.

In this case, the antenna node may mean a group of antenna elements, which are arranged in a same location. In particular, in case of a CAS, the CAS has one antenna node. In case of a DMNS, the DMNS may correspond to a system including at least one antenna node,

And, the antenna node can be used as a same meaning with such a terminology as a ‘node’, an ‘antenna port (or element) group’, an ‘antenna port’, a ‘distributed antenna unit (DA)’, an ‘antenna group’, an ‘antenna cluster’, a base station (BS, Node-B, eNode-B), a ‘pico base station (pico-cell eNB (PeNB))’, a ‘home base station (home eNB (HeNB))’, an ‘RRH’, a ‘relay’, a ‘repeater’. Meanwhile, the terminology ‘node’ may mean a random CSI-RS port or a pattern as mentioned in the following description.

Referring to FIG. 1 and FIG. 2, all antenna nodes are managed by a single controller to transmit and receive and then an individual antenna node may be able to operate as if the individual antenna node is a part of an antenna group of one cell. In this case, individual antenna nodes may be provided with a separate node ID or may be able to operate as a part of antenna group in a cell without a separate node ID.

And, if the individual antenna nodes perform a scheduling and a handover in a manner of having a separate cell identifier (ID), this may correspond to a multi cell (e.g., macro-/femto-/pico-cell) system.

And, if the multi cell is configured in a form of being overlaid according to coverage, this is called a multi-tier network.

In the following description, a reference signal (RS) is briefly described.

A reference signal is classified into a common reference signal (CRS), a dedicated reference signal (DRS), and a channel state information (or indication) reference signal (CSI-RS).

Common Reference Signal (CRS)

A CRS is used for a channel estimation of a physical antenna end and the CRS is a reference signal capable of being commonly received by all UEs within a cell. The CRS is distributed across full bands. The CRS can be used for the purpose of obtaining channel state information (CSI) and demodulating data.

Various forms of CRS can be defined according to antenna configuration of a transmitting side (base station). 3GPP LTE (release-8) system supports various antenna configurations. A downlink signal transmitting side (base station) includes 3 types of antenna configuration including a single antenna, 2 transmission antennas, and 4 transmission antennas. In case that the base station performs a single antenna transmission, a reference signal for a single antenna port is arranged. In case that the base station performs 2 antennas transmission, a reference signal for 2 antenna ports is arranged by a time division multiplexing and/or a frequency division multiplexing scheme. In particular, the reference signal for 2 antenna ports can be distinguished from each other in a manner of being assigned to a different time resource and/or a different frequency resource. And, in case that the base station performs 4 antennas transmission, a reference signal for 4 antenna ports is arranged by a TDM/FDM scheme. Channel information estimated by a downlink signal receiving side (user equipment) via the CRS can be used for demodulating a data, which is transmitted by such a transmission scheme as a single antenna transmission, a transmit diversity, a closed-loop spatial multiplexing, an open-loop spatial multiplexing, a multi-user MIMO (MU-MIMO), and the like.

In case of supporting a multi-antenna, if a reference signal is transmitted by an antenna port, the reference signal is transmitted to a designated resource element (RE) position according to a reference signal pattern and no signal is transmitted to the resource element (RE) position designated for a different antenna port.

In order to enhance a channel estimation performance via the CRS, it is able to vary a position of the CRS on a frequency domain according to a cell in a manner of shifting the position of the CRS. For instance, in case that the CRS is situated on every 3 subcarrier, a cell can be assigned to a subcarrier of 3 k and a different cell can be assigned to a subcarrier of 3 k+1. In terms of a single antenna port, a reference signal is assigned by 6 REs interval (i.e., 6 subcarriers interval) in a frequency domain and the reference signal maintains 3 REs interval with the RE to which a reference signal for a different antenna port is assigned in the frequency domain.

And, the CRS is differently assigned according to a length of CP (a normal CP and an extended CP).

Dedicated Reference Signal (DRS)

In a system having an extended antenna configuration to reduce an overhead of a reference signal, it is able to consider to introduce a UE-specific reference signal, i.e., a dedicated reference signal (DRS) to support a data transmission via an added antenna.

When a DRS for a new antenna port is designed, it is necessary to consider a CRS pattern, frequency shift of the CRS, and power boosting. Specifically, the frequency shift of the CRS and the power boosting are considered to enhance a channel estimation performance by the CRS. As mentioned earlier, the frequency shift means to differently configure a starting point of the CRS according to a cell. The power boosting means to bring power not from the RE assigned for a reference signal but from a different RE among the REs in one OFDM symbol. Meanwhile, the DRS can be configured to have a frequency interval different from that of the CRS. If the CRS and the DRS exist in an identical OFDM symbol, the position of the CRS and the position of the DRS can be overlapped according to the aforementioned frequency shift and the power boosting of the CRS may cause a negative effect on a DRS transmission.

And, since the DRS is a reference signal for a data demodulation, the DRS is positioned at a region to which a data channel is assigned.

Channel State Information Reference Signal (CSI-RS)

Compared to a system having a legacy antenna configuration (e.g., 4 transmission antennas supportive of LTE release 8 system), a system having an extended antenna configuration (e.g., 8 transmission antennas supportive of LTE-A system) is required to transmit a new reference signal to obtain a channel state information.

In case of channel information necessary for obtaining the CSI compared to channel information required to perform a data demodulation, although accuracy of channel estimation via a reference signal is relatively low, it is sufficient to obtain the CSI by using the channel information. Hence, the reference signal (CSI-RS) designed for the purpose of obtaining the CSI can be designed to have a relatively lower density compared to a legacy reference signal. For instance, the CSI-RS can be transmitted by such a duty cycle as 2 ms, 5 ms, 10 ms, 40 ms, and the like in a time domain and an RS having such an interval as 6 REs or 12 REs intervals can be transmitted on a frequency domain. In this case, the duty cycle means a time unit capable of obtaining all reference signals for the antenna port, which is used for a transmission. And, the CSI-RS can be transmitted across full bands on the frequency band.

In order to reduce an overhead of the CSI-RS, which is transmitted in one subframe, the reference signal for each of the antenna ports can be transmitted in a subframe different from each other. Yet, it should transmit the CSI-RS capable of supporting all antenna ports according to the extended transmission antenna in the duty cycle.

In the following description, the channel state information reference signal (CSI-RS) is described in more detail.

1. Multiple Configurations

Unlike the CRS, the CSI-RS proposes maximum 32 types of configurations, which are different from each other, to reduce an inter-cell interference (ICI) in a multi-cell environment in a manner of including a heterogeneous network (HetNet) environment.

Configuration for the CSI-RS varies according to the number of antenna port within a cell and it is configured as different as possible between adjacent cells. And, the configuration is divided according to a type of a cyclic prefix (CP). The configuration for the CSI-RS is classified into a case that the configuration is applied to both a FS 1 and a FS 2 and a case that the configuration is applied to the FS 2 only according to a type of a frame structure (FS). Lastly, unlike the CRS, the CSI-RS supports up to maximum 8 ports (p=15, p=15, 16, p=15, . . . , 18, p=15, . . . , 22) and is defined for Δf=15 kHz only.

The following Table 1 indicates an example of CSI-RS configuration for a normal CP

TABLE 1

| | CSI | | | | | | |
|---|---|---|---|---|---|---|---|
| | reference | Number of CSI reference signals configured | | | | | |
| | signal | 1 or 2 | | 4 | | 8 | |
| | configuration | (k′, l′) | nₛ mod 2 | (k′, l′) | nₛ mod 2 | (k′, l′) | nₛ mod 2 |
| Frame | 0 | (9, 5) | 0 | (9, 5) | 0 | (9, 5) | 0 |
| structure | 1 | (11, 2) | 1 | (11, 2) | 1 | (11, 2) | 1 |
| type 1 | 2 | (9, 2) | 1 | (9, 2) | 1 | (9, 2) | 1 |
| and 2 | 3 | (7, 2) | 1 | (7, 2) | 1 | (7, 2) | 1 |
| | 4 | (9, 5) | 1 | (9, 5) | 1 | (9, 5) | 1 |
| | 5 | (8, 5) | 0 | (8, 5) | 0 | | |
| | 6 | (10, 2) | 1 | (10, 2) | 1 | | |
| | 7 | (8, 2) | 1 | (8, 2) | 1 | | |
| | 8 | (6, 2) | 1 | (6, 2) | 1 | | |
| | 9 | (8, 5) | 1 | (8, 5) | 1 | | |
| | 10 | (3, 5) | 0 | | | | |
| | 11 | (2, 5) | 0 | | | | |
| | 12 | (5, 2) | 1 | | | | |
| | 13 | (4, 2) | 1 | | | | |
| | 14 | (3, 2) | 1 | | | | |
| | 15 | (2, 2) | 1 | | | | |
| | 16 | (1, 2) | 1 | | | | |
| Frame | 17 | (0, 2) | 1 | | | | |
| structure | 18 | (3, 5) | 1 | | | | |
| type 2 | 19 | (2, 5) | 1 | | | | |
| only | 20 | (11, 1) | 1 | | | | |
| | 21 | (9, 1) | 1 | | | | |
| | 22 | (7, 1) | 1 | | | | |
| | 23 | (10, 1) | 1 | | | | |
| | 24 | (8, 1) | 1 | | | | |
| | 25 | (6, 1) | 1 | | | | |
| | 26 | (5, 1) | 1 | | | | |
| | 27 | (5, 1) | 1 | | | | |
| | 28 | (3, 1) | 1 | | | | |
| | 29 | (2, 1) | 1 | | | | |
| | 30 | (1, 1) | 1 | | | | |
| | 31 | (0, 1) | 1 | | | | |

The following Table 2 indicates an example of CSI-RS configuration for an extended CP.

TABLE 2

| | | Number of CSI reference signals configured | | | | | |
|---|---|---|---|---|---|---|---|
| | CSI-RS | 1 or 2 | | 4 | | 8 | |
| | configuration | (k′, l′) | nₛ mod 2 | (k′, l′) | nₛ mod 2 | (k′, l′) | nₛ mod 2 |
| Frame | 0 | (11, 4) | 0 | (9, 5) | 0 | (9, 5) | 0 |
| structure | 1 | (9, 4) | 0 | (11, 2) | 0 | (11, 2) | 0 |
| type 1 | 2 | (10, 4) | 1 | (9, 2) | 1 | (9, 2) | 1 |
| and 2 | 3 | (9, 4) | 1 | (7, 2) | 1 | (7, 2) | 1 |
| | 4 | (5, 4) | 0 | (9, 5) | 0 | (9, 5) | |
| | 5 | (3, 4) | 0 | (8, 5) | 0 | | |
| | 6 | (4, 4) | 1 | (10, 2) | 1 | | |
| | 7 | (3, 4) | 1 | (8, 2) | 1 | | |
| | 8 | (8, 8) | 0 | (6, 2) | | | |
| | 9 | (6, 4) | 0 | (8, 5) | | | |
| | 10 | (2, 4) | 0 | | | | |
| | 11 | (0, 4) | 0 | | | | |
| | 12 | (7, 4) | 1 | | | | |
| | 13 | (6, 4) | | | | | |
| | 14 | (1, 4) | 1 | | | | |
| | 15 | (0, 4) | 1 | | | | |
| | 16 | (11, 1) | 1 | (11, 1) | 1 | (11, 1) | 1 |
| | 17 | (10, 1) | 1 | (10, 1) | 1 | (10, 1) | 1 |
| | 18 | (9, 1) | 1 | (9, 1) | 1 | (9, 1) | 1 |
| | 19 | (5, 1) | 1 | (5, 1) | 1 | | |
| Frame | 20 | (4, 1) | 1 | (4, 1) | 1 | | |
| structure | 21 | (3, 1) | 1 | (3, 1) | 1 | | |
| type 2 | 22 | (8, 1) | 1 | | | | |
| only | 23 | (7, 1) | 1 | | | | |
| | 24 | (6, 1) | 1 | | | | |
| | 25 | (2, 1) | 1 | | | | |
| | 26 | (1, 1) | 1 | | | | |
| | 27 | (0, 1) | 1 | | | | |

2. Resource Mapping

In a subframe configured to transmit a CSI-RS, a reference signal (RS) sequence r_{l,n}_{ₛ}(m) is mapped to a complex-valued modulation symbol a_{k,l}^{(p)}, which is used as a reference symbol for an antenna port p according to the following Formula 1.

a_{k,l}^{(p)}=w_{l″}·r(m) [Formula 1]

In this case,

$$k = {k}^{′} + 12 m + \{ \begin{matrix}- 0 & for p ∈ \{ 15 , 16 \} , normal cyclic prefix \\ - 6 & for p ∈ \{ 17 , 18 \} , normal cyclic prefix \\ - 1 & for p ∈ \{ 19 , 20 \} , normal cyclic prefix \\ - 7 & for p ∈ \{ 21 , 22 \} , normal cyclic prefix \\ - 0 & for p ∈ \{ 15 , 16 \} , extended cyclic prefix \\ - 3 & for p ∈ \{ 17 , 18 \} , extended cyclic prefix \\ - 6 & for p ∈ \{ 19 , 20 \} , extended cyclic prefix \\ - 9 & for p ∈ \{ 21 , 22 \} , extended cyclic prefix\end{matrix} \\ l = {l}^{′} + \{ \begin{matrix}{l}^{″} & CSI reference signal configurations 0 \text{-} 19 , normal cyclic prefix \\ 2 {l}^{″} & CSI reference signal configurations 20 \text{-} 31 , normal cyclic prefix \\ {l}^{″} & CSI reference signal configurations 0 \text{-} 27 , extended cyclic prefix\end{matrix} \\ {w}_{{l}^{″}} = \{ \begin{matrix}1 & p ∈ \{ 15 , 17 , 19 , 21 \} \\ {( - 1 )}^{{l}^{″}} & p ∈ \{ 16 , 18 , 20 , 22 \}\end{matrix} \\ {l}^{″} = 0 , 1 \\ m = 0 , 1 , … , {N}_{RB}^{DL} - 1 \\ {m}^{′} = m + ⌊ \frac{{N}_{RB}^{max , DL} - {N}_{RB}^{DL}}{2} ⌋$$

The CSI-RS of a multi configuration is usable in a given cell.

First of all, in case of a non-zero power CSI-RS, a base station transmits only the CSI-RS for a single configuration to a user equipment.

And, in case of a zero power CSI-RS, the base station may be able to transmit the CSI-RS for the multi configuration. And, the base station may not transmit the CSI-RS to the user equipment.

In this case, a case that the base station does not transmit the CSI-RS is described in the following description.

1) a specific subframe of a FS 2

2) in case of collision with synchronization signals, PBCH, or a system information block (SIB) 1

3) a subframe to which a paging message is transmitted

In a set S, a resource element (RE) (k, l) used to transmit the CSI-RS in an antenna port is not utilized to transmit PDSCH by any antenna port in an identical slot and no antenna port is used for the CSI-RS except the elements of the set S in the identical slot.

3. Subframe Configuration

The CSI-RS supports 5 types of duty cycles according to CQI/CSI feedback and the CSI-RS can be transmitted in each cell in a manner of having a subframe offset different from each other.

(1) cell-specific subframe configuration period: T_{CSI-RS}

(2) cell-specific subframe offset: Δ_{CSI-RS}

(3) CSI-RS-subframeConfig: provided by higher layer

(4) a subframe including CSI-RS should satisfies the following Formula 2.

(10n_{f}└nₛ/2┘−Δ_{CSI-RS})mod T_{CSI-RS}=0 [Formula 2]

The following Table 3 indicates an example of a CSI-RS subframe configuration related to a duty cycle.

```
TABLE 3
CSI-RS-SubframeConfig I_{CSI-RS}
0-4
  5-14
15-34
35-74
  75-154
```

4. Sequence Generation

A sequence r_{l,n}_{ₛ}^{(m)} for a CSI-RS is generated by Formula 3 as follows.

$${r}_{l , {n}_{s}} ( m ) = \frac{1}{\sqrt{2}} ( 1 - 2 \cdot c ( 2 m ) ) + j \frac{1}{\sqrt{2}} ( 1 - 2 \cdot c ( 2 m + 1 ) ) , \\ m = 0 , … , {N}_{RB}^{max , DL} - 1 \\ , {c}_{init} = {2}^{10} \cdot ( 7 \cdot ( {n}_{s} + 1 ) + l + 1 ) \cdot ( 2 \cdot {N}_{ID}^{cell} + 1 ) + 2 \cdot {N}_{ID}^{cell} + {N}_{CP} \\ {N}_{CP} = \{ \begin{matrix}1 & for normal CP \\ 0 & for extended CP\end{matrix} \qquad [ Formula 3 ]$$

5. CSI-RS Definition

CSI-RS related parameters are cell-specific and are configured via a higher layer signaling.

(1) Number of CSI-RS ports or number of CSI-RS patterns

(2) CSI-RS configuration

(3) CSI-RS subframe configuration (I_{CSI-RS})

(4) Subframe configuration period (T_{CSI-RS})

(5) Subframe offset (Δ_{CSI-RS})

A user equipment estimates a reference PDSCH transmit power for a CSI feedback P_{C}.

The P_{C} corresponds to an estimation ratio of PDSCH EPRE to CSI-RS EPRE in case that a user equipment performs a CSI feedback. The P_{C} has a size of 1 dB interval in a range of [−8, 15] dB.

In this case, the EPRE (Energy Per Resource Element) indicates energy per resource element. The EPRE means the energy or a transmit power for the resource element to which one reference symbol or a data symbol is mapped.

The following Table 4 is an example indicating the number of intra-cell CSI RS configuration according to a CP type, a frame structure type, and the number of antenna port in LTE-A Rel-10.

TABLE 4

Number of CSI-RS configurations

| | Frame | 2 ports | 4 ports | 8 ports |
|---|---|---|---|---|
| CP Type | Structure | CSI_RS | CSI_RS | CSI_RS |
| Normal | Type 1&2 | 20 | 10 | 5 |
| CP | Type 2 | 12 | 6 | 3 |
| | Total | 32 | 16 | 8 |
| Extended | Type 1&2 | 16 | 8 | 4 |
| CP | Type 2 | 12 | 6 | 3 |
| | Total | 28 | 14 | 7 |

### 1^{st} Embodiment

In the following description, a method of configuring and transmitting a CSI-RS for a channel measurement and a node detection in a distributed multi-node system (DMNS) proposed by the present specification is described in detail.

An Intra-Cell Non-Zero CSI-RS Including Multi Configuration

First of all, the present specification proposes a plurality of configurations (or multiple configurations) of an intra-cell non-zero CSI-RS in the distributed multi-node system according to one embodiment of the present specification.

In particular, the present specification provides a method of transmitting a non-zero as well as a zero power CSI-RS, which includes a plurality of configurations in a distributed multi-node system (DMNS), to a user equipment via various configuration forms.

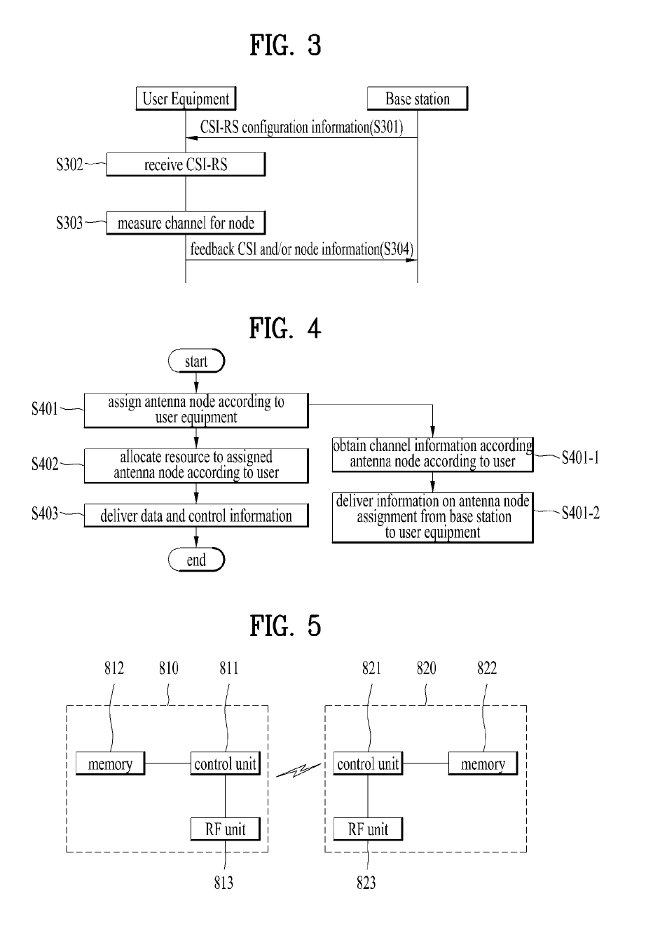

FIG. 3 is a flowchart of a method of transmitting a CSI-RS according to one embodiment of the present specification.

A base station transmits CSI-RS configuration information indicating a configuration of a non-zero power CSI-RS to a user equipment [S301]. In this case, the CSI-RS configuration information corresponds to CSI-RS related control information indicating a plurality of configurations of the non-zero power CSI-RS. And, the CSI-RS configuration information is cell-specifically transmitted to the user equipment via a signaling of an upper layer from the base station.

In the following description, the CSI-RS related control information in LTE-A Rel-10, in particular, a CSI-RS parameter (1) to (7) are briefly explained. Similarly, the CSI-RS parameters are cell-specifically transmitted to the user equipment via a signaling of the upper layer.

(1) Number of CSI-RS ports or number of CSI-RS patterns

(2) Number of CSI-RS configuration

(3) CSI-RS subframe configuration (I_{CSI-RS})

(4) Subframe configuration period (T_{CSI-RS})

(5) Subframe offset (Δ_{CSI-RS})

(6) Ratio of PDSCH EPRE to CSI-RS EPRE: P_{C}

(7) Zero power CSI-RS configuration

First of all, the parameter (1) and (2) are the parameters related to a configuration within a subframe of an intra-cell CSI RS. A base station transmits the number of CSI-RS port or the number of pattern to a user equipment via the parameter (1) of a size of 2 bits and the base station transmits a CSI-RS configuration of the number of a corresponding port or the number of pattern to the user equipment via the parameter (2) of a size of 5 bits.

The parameter (3) to (5) correspond to the parameters related to a subframe configuration of CSI-RS and include the content of the Table 3.

The base station transmits a position of the CSI-RS, a duty cycle, and the like transmitted via I_{CSI-RS} of the parameter (3) to the user equipment.

The parameter (6) is a parameter indicating a power ratio of PDSCH resource element to CSI-RS RE. The base station enables the user equipment to estimate a relative power of the PDSCH to the CSI-RS.

In this case, the EPRE indicates energy per resource element (hereinafter abbreviate EPRE). The EPRE means the energy or a transmit power for a resource element to which one reference symbol or a data symbol is mapped.

The parameter (7) corresponds to a zero power CSI-RS configuration bitmap, which is configured with 16 bits on the basis of 4 ports or a pattern CSI-RS configuration. The base station enables the user equipment to identify a position to which a data is not transmitted (muted RE), although a CSI-RS does not practically exist, via the parameter (7) and enables the user equipment to perform a rate matching for the muted RE.

Non-Zero Power CSI-RS Including a Plurality of Configurations in One Subframe

As one example of the present specification, the CSI-RS configuration information may be able to indicate a non-zero power CSI-RS configuration including a plurality of configurations in one subframe.

In this case, the base station may be able to transmit the parameter (1) and (2) (in particular, the number of CSI-RS port or pattern and the number of CSI-RS configuration) to the user equipment in a manner that 1) both a cell-specific CSI-RS and a node-specific CSI-RS are all included, 2) only the cell-specific CSI-RS is included, or 3) only the node-specific CSI-RS is included. In this case, the cell-specific CSI-RS can be configured by a method described in the following description.

First, the cell-specific CSI-RS can be configured to be identically transmitted to both a distributed multi-node system supportive of user equipment and LTE-A Rel-10 user equipment.

Second, the cell-specific CSI-RS can be configured to transmit a plurality of the non-zero power CSI-RSs to the distributed multi-node system supportive of user equipment only in a manner of broadcast or unicast.

In this case, the first case for the cell-specific CSI-RS configuration corresponds to the configuration for the CSI-RS in the legacy LTE-A rel-10. Hence, a signaling from a base station to a user equipment is identical to that of the legacy LTE-A Rel-10. In this case, LTE-A Rel-10 user equipment may be able to maintain a conventional operation as it is. Yet, the base station may be able to separately signal a control information for a node-specific CSI-RS to the user equipment for the user equipment supporting the distributed multi-node system. In this case, it is preferable for the user equipment to transmit a feedback on the cell-specific CSI-RS and a feedback on the node-specific CSI-RS to the base station to have a full resolution for a whole node within a cell.

In case of the second case for the cell-specific CSI-RS configuration, the cell-specific CSI-RS can be received by the user equipment supporting the distributed multi-node system only. A signaling, which is independent of the signaling for the CSI-RS in the legacy LTE-A Rel-10, is transmitted to the user equipment.

In this case, the control information for the node-specific CSI-RS is transmitted only for the user equipment supporting the distributed multi-node system.

And, the parameter (1), in particular, the number of CSI-RS ports or the number of CSI-RS patterns can be applied to both the cell-specific CSI-RS and the node-specific CSI-RS as an identical value. In this case, the parameter (1) can be transmitted as one value only.

And, the parameter (2), in particular, the number of CSI-RS configuration can be transmitted to the user equipment in a form of a plurality of (or multiple) CSI-RS configuration indexes or in a form of a CSI-RS configuration bitmap.

In this case, the form of a plurality of (or multiple) the CSI-RS configuration indexes may use the form of 5 bits regarding the number of the CSI-RS configuration in the legacy LTE-A Rel-10.

And, the form of the CSI-RS configuration bitmap indicates a CSI-RS configuration, which is assigned using a bitmap of a total of 32 bits on the basis of 1 and 2 port CSI-RS configuration, and then the CSI-RS configuration can be transmitted to the user equipment.

And, as a different example of the present specification, in case of a DMNS capable of performing a joint transmission for a plurality of nodes, it is able to assume that a single stream is transmitted for each of a plurality of the nodes or is transmitted for each of a plurality of the nodes except a center node in a manner of considering a transmission for the base station and a feedback overhead.

Hence, a mapping relationship with the CSI-RS, which is transmitted to the user equipment by the base station, may follow a method as follows.

First, a random CSI-RS port or a pattern is mapped to a node.

Second, a random CSI-RS port or a pattern is mapped to an antenna element.

Third, a part of port of a CSI-RS or a pattern is mapped to a node and a part of port or a pattern is mapped to an antenna element.

In this case, in case of the first case that the CSI-RS port or pattern is mapped to a node, the base station informs the user equipment of the number of antenna elements per node via a separate signaling.

A Plurality of Non-Zero CSI-RS Configurations within a Plurality of Subframes

As a different example of the present specification, the CSI-RS configuration information may be able to indicate a non-zero power CSI-RS configuration including a plurality of configurations in a plurality of subframes.

A CSI-RS in a legacy LTE-A Rel-10 can be transmitted in a manner of including 5 duty cycles different from each other and can be transmitted in a manner of including various subframe configurations (I_{CSI-RS}) for each of the duty cycles. Yet, a non-zero power CSI-RS in LTE-A Rel-10 includes one subframe configuration only within a subframe. This is proposed to minimize collision of a CSI-RS in a network environment that a plurality of cells and nodes are overlapped or adjacent to each other, although maximum 32 configurations, which are orthogonal to time/frequency domain, exist in one subframe. Yet, since a distributed multi-node system has a plurality of nodes within an intra-cell, the number of ports or patterns simultaneously transmittable in one subframe of a CSI-RS may be insufficient.

Hence, the base station defines the non-zero CSI-RS of the intra-cell to transmit a plurality of configurations to the user equipment via at least one subframe.

For instance, in case of transmitting a CSI-RS for a total of 20 ports or patterns, the CSI-RS of 8, 8, 4 ports can be sequentially transmitted via I_{CSI-RS}=0 subframe (1^{st} subframe), I_{CSI-RS}=1 subframe (2^{nd} subframe), and I_{CSI-RS}=3 subframe (3^{rd} subframe), respectively. In particular, the base station transmits a plurality of CSI-RS configurations for the parameter (3) to (5) (in particular, I_{CSI-RS}, T_{CSI-RS}, Δ_{CSI-RS}) to the user equipment via a method as follows.

First, for at least one CSI-RS subframe transmitting one CSI-RS, an independent signaling is performed for at least one parameter according to each of the subframes.

In particular, according to the first method, one CSI-RS transmitted via at least one CSI-RS subframe can be transmitted in a manner of including I_{CSI-RS} different from each other of an identical T_{CSI-RS} according to each of the subframes (in particular, an identical duty cycle and a subframe configuration different from each other).

Or, one CSI-RS transmitted via at least one CSI-RS subframe can be transmitted in a manner of including I_{CSI-RS} different from each other of T_{CSI-RS} different from each other (in particular, a duty cycle different from each other and a subframe configuration different from each other).

Second, for at least one CSI-RS subframe transmitting one CSI-RS, the rest of the CSI-RS is transmitted in a manner of including a sequential subframe offset (Δ′_{CSI-RS}) on the basis of a first subframe.

In particular, according to the second method, in case of Δ_{CSI-RS}(=I_{CSI-RS})(Δ′_{CSI-RS}=0) for I_{CSI-RS}=0 subframe (1^{st} subframe), a CSI-RS can be transmitted in a manner that a second subframe includes a subframe=offset of Δ′_{CSI-RS}=Δ_{CSI-RS}+1 and a third subframe includes a subframe offset of Δ′_{CSI-RS}=Δ_{CSI-RS}+2. Or, it may be assigned within T_{CSI-RS} the for the I_{CSI-RS} of the first subframe by an identical interval.

And, the base station may not perform a separate transmission except the transmission of information on the first subframe to the user equipment. In this case, the number of subframes to which the CSI-RS is transmitted should be separately indicated.

Third, at least one CSI-RS subframe transmitting one CSI-RS is transmitted in a manner of including a duty cycle (T_{CSI-RS}) of n times (n=1, 2, . . . , N) for the T_{CSI-RS} of the CSI-RS subframe. In particular, in this case, a practical duty cycle of the CSI-RS subframe becomes N*T_{CSI-RS}.

In this case, N indicates the number of CSI-RS subframe.

In particular, according to the third method, in case that a first subframe configuration I_{CSI-RS} of the CSI-RS is 0 and T_{CSI-RS} is 5, the CSI-RS is sequentially transmitted via a subframe of I_{CSI-RS}=0, a subframe of I_{CSI-RS}=5, and a subframe of I_{CSI-RS}=10. In particular, the CSI-RS is transmitted via the duty cycle of n times (n=0, 1, 2, . . . , N where N: number of CSI-RS subframes) of T_{CSI-RS} for a first subframe of the CSI-RS and the subframe configuration.

In this case, the base station may be able to transmit the non-zero power CSI-RS including a plurality of configurations in a plurality of subframes to the DMNS supportive of user equipment in a manner of a multicast or a unicast scheme.

P_{C} Transmission

As an example of the present specification, the base station UE-specifically transmits P_{C}.

In this case, the P_{C} corresponds to a power ratio of CSI-RS EPRE to PDSCH EPRE. Consequently, the Pc indicates the power of a CSI-RS RE. Since a legacy CSI-RS includes a cell-specific configuration, the P_{C} practically indicates a cell-specific value in the legacy CSI-RS. Yet, in case of a DMNS, since a serving node may be different from each other according to a user equipment, in particular, since CSI-RS configuration is different from each other according to a user equipment, the base station transmits the P_{C} different from each other according to the user equipment.

Hence, in the distributed multi-node system, the base station transmits a UE-specific PC and the user equipment may be able to perform a precise channel estimation via the UE-specific P_{C}.

UE-Specific Zero CSI-RS Configuration Transmission

As an example of the present specification, the base station UE-specifically transmits a zero power CSI-RS configuration to the user equipment.

In this case, as described in the parameter (7), the zero power CSI-RS configuration indicates bitmap information on reserved REs according to a CSI-RS configuration although it does not have transmit power.

In LTE-A Rel-10, a user equipment recognizes that a data is not transmitted to corresponding REs based on the parameter (7). Transmission efficiency can be enhanced by performing a rate matching for the reserved REs. Although the zero power CSI-RS configuration can be configured independently from a non-zero power CSI-RS configuration, since a CSI-RS is cell-specific, the zero power CSI-RS configuration is cell-specific information as well.

Yet, in case of a distributed multi-node system, since a plurality of configurations and/or various configurations may exist according to a user equipment, each user equipment should have an independent zero power CSI-RS configuration.

Similar to the CSI-RS of a legacy LTE-A Rel-10, it may be able to use a 16-bit bitmap based on a 4 ports CSI-RS configuration. Yet, in case of the distributed multi-node system including a multi-node, it is preferable to use a 32-bit bitmap based on 1 and 2 ports CSI-RS configuration to secure a node resolution.

And, it is preferable that the base station transmits a configuration to the user equipment according to a UE and a CSI-RS in a manner of differently configuring the configuration (32, 16, 8 bit bitmap for 2, 4, 8 port CSI-RS configuration, respectively).

Information on the Maximum Number of Configuration of a Non-Zero CSI-RS in One Subframe

As an example of the present specification, the base station transmits information on the maximum number of configuration capable of being possessed by an intra-cell non-zero CSI-RS in one subframe.

The base station may be able to transmit a CSI-RS including a plurality of configurations in at least one subframe to the user equipment in the distributed multi-node system. In this case, if the number of nodes in a cell become tremendous, a plurality of CSI-RSs for the DMNS exist in the cell and this may lead to a high probability of collision with a CSI-RS of a base station in LTE-A Rel-10 of a neighboring cell and it may cause performance degradation. This contradicts a design criteria of CSI-RS multiple configurations to reduce CSI-RS collision probability between a plurality of inner-cells and a neighbor cell in a heterogeneous network (HetNet) environment.

Hence, in order to solve this kind of problem, the base station defines the maximum number of non-zero power eCSI-RS configuration according to a port, a type of cyclic prefix (CP), a frame structure type, and the like.

The following Table 5 is a table indicating one example of the maximum number of non-zero power eCSI-RS configuration capable of being simultaneously assigned to a cell.

TABLE 5

| CP Type | Frame Structure |
|---|---|
| Normal CP | Type1&2 |
| | Type2 |
| | Total |
| Extended CP | Type1&2 |
| | Type2 |
| | Total |

In particular, the base station transmits the information (N_{MaxNumber}ofeCSI-RSconfig) on the maximum number of eCSI-RS configuration available in one cell to the user equipment.

CSI-RS Type Indicator Transmission

As an example of the present specification, the base station transmits a CSI-RS type indicator indicating a use of a CSI-RS to the user equipment.

In particular, the CSI-RS indicator is indication information indicating whether the CSI-RS transmitted to the user equipment by the base station is for 1) a CSI feedback or 2) a node information feedback.

In particular, the base station may be able to transmit the CSI-RS to the user equipment to perform a measurement for the aforementioned two things, i.e., 1) or 2). The base station may be able to transmit the CSI-RS including a periodicity different from each other according to a type of feedback of the user equipment (or the use of the CSI-RS) to the user equipment.

And, the CSI-RS type indicator can be transmitted to the user equipment cell-specifically or UE-specifically.

In this case, the base station may be able to generate a CSI-RS sequence using a cell ID different from each other according to the use of the CSI-RS.

In particular, the base station generates the CSI-RS sequence using a cell ID subset different from each other according to the type of feedback of the user equipment (or the use of the CSI-RS).

In this case, the cell ID is applied to the CSI-RS sequence generation as an identifier for a node. Yet, unlike a physical cell identifier (PCI), the cell ID means the identifier not applied to a CRS sequence generation or simply means the identifier configured to distinguish a node.

UE-Specific CSI-RS Port or Pattern Mapping Information Transmission

As an example of the present specification, the base station may be able to transmit a UE-specific CSI-RS port or pattern mapping information to the user equipment in relation to a CSI-RS transmission.

In case of transmitting a CSI-RS, the base station may be able to transmit a cell-specific CSI-RS to the user equipment. In this case, the CSI-RS for at least one user equipments can be included in one CSI-RS configuration. In this case, the user equipment may be able to read the CSI-RS corresponding to the user equipment only according to the UE-specific CSI-RS pattern mapping information.

Channel Measurement of User Equipment Via CSI-RS

After receiving the CSI-RS configuration information from the base station [S301], the user equipment receives a CSI-RS via at least one node based on the received CSI-RS configuration information [S302]. In particular, the user equipment receives the CSI-RS via the at least one node via one subframe or a plurality of subframes.

Thereafter, the user equipment performs a channel measurement for the at least one node using the CSI-RS transmitted on the at least one node [S303]. In this case, the at least one node may correspond to serving nodes or candidate nodes of the user equipment.

Thereafter, the user equipment feedbacks at least one of a channel state information (CSI) and a node information to the base station [S304].

In this case, the channel state information (CSI) may correspond to a CQI, a PMI, an RI, or an SINR. And, the node information includes at least one selected from the group consisting of a cell ID, antenna port information, a CSI-RS configuration, a CSI-RS subframe configuration, a CSI for a node, and a node index.

In case of a user equipment supporting a distributed multi-node system, the user equipment receives a node or a CSI-RS for an antenna from the base station.

1. Cell-Specific Antenna (Node)

(1) an antenna positioned at a same location in a base station (basic antenna information for LTE-A Rel-10 system or a previous system, i.e., antenna information centering on a cell)

(2) The whole antenna (or node) installed in a base station or a cell (or, the whole antenna not including the information of the (1))

2. UE-Specific Antenna (Node)

(1) Antenna for a UE-specific node subset, which is selected by a base station or a user equipment according to the measurement of the 1.

(2) Antenna for a serving node of current user equipment

The user equipment performs a channel measurement (or estimation) for at least one node (or antenna) via a non-zero power CSI-RS transmitted from the base station.

Thereafter, the user equipment feedbacks channel state information for the channel measurement to the base station (eNode B). In this case, the user equipment may be able to feedback the whole nodes or at least one of a CQI, a PMI, an RI according to a node to the eNode B.

And, the user equipment may be able to feedback node information including at least one selected from the group consisting of a cell ID, antenna port information, a CSI-RS configuration, a CSI-RS subframe configuration, a CSI for a node, and a node index to the base station based on the CSI.

As an example, when the user equipment feedbacks a CSI for the node (or antenna) to the base station, if the user equipment has a high mobility, the user equipment performs a channel estimation for the 1. (1) and a CSI feedback.

As an example, in order to reduce a feedback overhead to the base station, the user equipment performs CSI estimation for the 2. (1) and a CSI feedback for the 2. (1) with a long term and performs the CSI estimation for the 2. (2) and the CSI feedback for the 2. (2) with a short term.

As an example, besides the CSI-RS for the CSI feedback, the user equipment applies a sequence for a node identifier or a cell identifier. Or, the user equipment feedbacks a node information (e.g., at least one selected from the group consisting of a node ID, a cell ID, an antenna port, a CSI-RS configuration, a CSI-RS subframe configuration, a CSI for a node) for the CSI-RS distinguished by the CSI-RS type indicator to the base station. In other word, the user equipment feedbacks the information on each node to the base station according to a pattern of the CSI-RS.

And, in case of performing a feedback on the CSI and/or the node information, the user equipment may be able to feedback to the base station using one of the methods described in the following description.

First, for the CSI-RS including a plurality of CSI-RS configurations,

The user equipment feedbacks the CSI and/or the node information according to full band or a bandwidth.

Second, for the CSI-RS including a plurality of CSI-RS subframe configurations,

The user equipment feedbacks an integrated CSI and/or the node information on each of the channel measured nodes or the currently known node on the basis of a first subframe to the base station.

In case of the second case, assume that the CSI-RS for the total of 16 nodes is transmitted via the total of 2 subframes (8 nodes each).

The user equipment may be able to feedback each of the CSI and each of the node information on the first 8 nodes to the base station. Moreover, the user equipment may be able to feedback the CSI and the node information on each of the node combinations for the 8 nodes to the base station.

After receiving a second CSI-RS subframe, the user equipment may be able to perform a feedback on the CSI and/or the node information on each of the rest of 8 nodes.

Moreover, the user equipment may be able to feedback the CSI and/or the node information on the rest of combinations except the node combination obtained in the first subframe among the combinations for the total of 16 nodes to the base station.

The aforementioned CSI and/or the node information feedback performed by the user equipment can be performed for a full band, a bandwidth, a best band, or the like.

RSSI, RSSP, RSRO Measurement Using CSI-RS

In the following description, RSSI, RSSP, RSRO measurement performed by the user equipment in a distributed multi-node system and related contents for node selection (or detection) are described.

In the distributed multi-node system, the base station may be able to transmit the CSI-RS to enable the user equipment to measure an RSSI, an RSRP, an RSRQ, and the like for each node.

In this case, the user equipment feedbacks a node information (e.g., a node index, a node configuration, a cell ID, an antenna port), which is detected (or selected) using RSSI, RSRP, RSRQ (reference signal strength indication (indicator)), (reference signal received power), (reference signal received quality), and the like measured by a unique pattern of the CSI-RS for a whole node or a part of the nodes in a cell, to the base station. In particular, by performing a measurement for the RSRP, the RSRQ, the RSSI using the pattern of the CSI-RS in the distributed multi-node system, the user equipment may be able to feedback the information related to node selection to the base station.

In this case, in case that the user equipment is able to perform a measurement for the RSSI, the RSRP, and the RSRQ according to each node via the CSI-RS, each of the RSSI, the RSRP, and the RSRQ can be defined as CSI-RSSI, CSI-RSRP, and a CSI-RSRQ, respectively.

In the following description, definition of each of the CSI-RSSI, the CSI-RSRP, and the CSI-RSRQ is briefly explained.

First of all, the CSI-RSRP (channel state information reference signal received power) is defined by a linear average for power contribution of resource elements transmitting CSI-RSs in a considered measurement frequency band. The CSI-RSRP, which is mapped according to each node, is used to determine the CSI-RSRP by the each node.

And, a reference point for the CSI-RSRP may correspond to an antenna connector of a user equipment.

In case that a user equipment uses a reception diversity technique, a reported value is not lower than a corresponding CSI-RSRP of a specific branch among each of the diversity branches.

The CSI-RSRQ (channel state information reference signal received quality) is defined by a ratio of N*CSI-RSRP/E-UTRA carrier CSI-RSSI. In this case, the N means the number of resource block of E-UTRA carrier CSI-RSSI measurement bandwidth.

Measurement for the values corresponding to the numerator and the denominator is performed for an identical set of the resource blocks.

The E-UTRA carrier CSI-RSSI (channel state information reference signal strength indication) consists of a linear average of a total of receiving power, which is observed only in an OFDM symbol including a CSI-RS in a measurement bandwidth.

Similarly, a reference point for the CSI-RSRQ may correspond to an antenna connector of a user equipment.

In case that a user equipment uses a reception diversity technique, a reported value is not lower than a corresponding CSI-RSRQ of a specific branch among each of the diversity branches.

As mentioned in the foregoing description, in case that a user equipment performs a measurement for the RSSI, the RSRP, the RSRQ, and the like in a manner of receiving a CSI-RS via at least one node in a distributed multi-node system, the user equipment may be able to feedback the informations (e.g., a node index, node configurations, a cell ID, an antenna port, etc.) related to a node detection and/or a node selection for the at least one node to the base station. The node detection and/or the node selection information on the at least one node can be performed with a long term compared to the CSI-RS transmission of the base station for a CSI feedback.

And, the base station may be able to cell-specifically or UE-specifically transmit the information for the at least one node detection and/or the node selection of the user equipment. In this case, the base station may be able to transmit a CSI-RS in a manner of constructing the CSI-RS designed for the node detection and/or node selection independent of the CSI-RS for CSI-RS feedback to enable the user equipment to perform the node detection and/or selection for at least one among the following node informations.

1. Cell Specific Antenna (Node) Information (Initial Access Information)

(1) Information on an antenna positioned at a same location in a base station (basic antenna information for LTE-A Rel-10 system or a previous system, i.e., antenna information centering on a cell)

(2) Information on the whole antenna installed in a base station or a cell (or, information on the whole antenna not including the information of the 1.(1))

2. UE-Specific Antenna (Node) Information

(1) Antenna for a UE-specific node subset, which is selected by a base station or a user equipment according to the measurement of the 1.

(2) Antenna for a serving node of current user equipment

The information of the 1.(1) is transmitted to the user equipment on PBCH and PDCCH.

The information of the 1.(2) may be transmitted to the user equipment using at least one method among the methods described in the following description.

First, the information is signaled to the user equipment via a SIBx.

In this case, the SIBx means a modified SIB2 and corresponds to a new SIB for a distributed multi-node system.

Second, the information can be implicitly transmitted to the user equipment via a CSI-RS configuration or a CSI-RS subframe configuration information.

The base station may be able to provide a separate CSI-RS to the user equipment for the nodes of the 1. To this end, the base station signals a cell-specific CSI-RS control information independent of the control information on the CSI-RS to the user equipment.

In this case, the CSI-RS for the 1.(1) and the 1.(2) can be independently transmitted to the user equipment. In particular, the CSI-RS related control information on the 1.(1) and the 1.(2) is independently configured and then transmitted to the user equipment.

Hence, the user equipment may be able to obtain information on the nodes recognizable within a cell via a CSI-RS measurement and may be then able to feedback the node information to the base station.

Information on the 2.(1) corresponds to a UE-specific information. The information is determined by the base station based on UE feedback for a whole node within a cell. Or, the user equipment determines the information and may be then able to transmit the information to the base station.

The base station may be able to transmit the CSI-RS for a UE-specific node subset independent of the CSI-RS for a CSI feedback and/or the CSI-RS for the aforementioned 1 to reduce operations for the node detection/selection and a CSI feedback overhead.

In particular, the base station UE-specifically transmits a separate signaling to transmit the CSI-RS for the 2.(1). The user equipment may be able to obtain the information on neighboring nodes via the CSI-RS measurement and may be then able to feedback the node information to the base station (eNode B).

The base station may be able to determine the nodes (e.g., a serving node) of the 2.(2) based on the corresponding information.

In particular, in case of transmitting a CSI-RS related parameter, by transmitting control information independent of the CSI-RS for the CSI feedback, the base station enables the user equipment to obtain the information on all nodes within a cell.

Hence, the base station transmits at least one information among the following informations to the user equipment to transmit the CSI-RS for detection and/or selection of the node (or antenna) independent of the CSI-RS for a CSI channel estimation.

1) Number of CSI-RS Port

2) Number of CSI-RS configuration

3) CSI-RS subframe configuration: I_{CSI-RS}

4) Subframe configuration period (T_{CSI-RS})

5) Subframe offset (Δ_{CSI-RS})

6) Ratio of PDSCH EPRE to CSI-RS EPRE: P_{C}

7) Zero power CSI-RS configuration

8) Number of available multiple eCSI-RS configurations

9) CSI-RS identifier

The base station assigns a (virtual) cell ID-based sequence independent of the CSI-RS for the CSI feedback.

Node Information Feedback to Base Station

In case of measuring a CSI-RS, the user equipment feedbacks at least one selected from the group consisting of a cell ID, antenna port information, a CSI-RS configuration, a CSI-RS subframe configuration to the base station.

In particular, in case that the user equipment is able to perform a measurement on RSSI, RSRP, RSRQ, and the like via the CSI-RS, after performing the channel measurement, the user equipment feedbacks at least one information among the following informations to the base station.

1. Cell ID (or Node ID)

If each node is mapped to each CSI-RS configuration and a separate cell ID (or node ID) is given to the each node, the user equipment feedbacks the cell ID (or node ID) as node information.

2. Antenna Port

In this case, the antenna port is transmitted with a form among the forms described in the following.

First, a logical index sequentially ordered for all nodes within a cell.

Second, a logical index ordered for all nodes transmitting a CSI-RS.

Third, a practical port number

In particular, if each node is mapped to each CSI-RS RE and a separate cell ID (or node ID) is given to the each node, the user equipment feedbacks antenna port information together with the cell ID (or node ID) and the base station may be then able to obtain node information on the user equipment.

3. CSI-RS Configuration

In this case, the CSI-RS configuration is transmitted with one form among the forms described in the following.

First, a concatenated index for a single configuration

Second, a bitmap for a whole configuration

In this case, the bitmap transmits a bitmap on the basis of 1 and 2 ports CSI-RS configuration (e.g., 32-bit bitmap), a bitmap on the basis of 4 ports CSI-RS configuration (e.g., 16-bit bitmap) or a separate bitmap according to the number of each CSI-RS port. In particular, in case that each node is mapped to each CSI-RS configuration, the user equipment feedbacks an index for the CSI-RS configuration or bitmap information and the base station may be then able to obtain node information.

4. CSI-RS Subframe Configuration

If each node is mapped to each CSI-RS configuration and the CSI-RS for the each node is transmitted via a subframe configuration different from each other, the user equipment performs a feedback on a CSI-RS subframe configuration and the base station may be then able to obtain node information from the feedback.

The aforementioned intra-cell CSI-RS indicates the CSI-RS not signaled with a separate PCI in an identical CSI-RS or a cell.

And, the node can be replaced by at least one selected from the group consisting of a cell, an antenna, (e)Node B, a base station. And, the node exists in a manner of being regionally apart from each other or includes an independent channel. In particular, the node may be able to have an independent coverage.

### 2^{nd} Embodiment

In the following description, a different embodiment proposed by the present specification is described. A method of transmitting control information to select (or determine) a valid node (or antenna node) in a distributed multi-node system is explained in detail. For clarity, a terminology ‘antenna node’ is only used in the following description.

First of all, a process of data transmission and reception between a base station and a user equipment in a DMNS (or DAS) shall be described.

FIG. 4 is a flowchart of a process for transmitting and receiving data between a base station and a user equipment in a DMNS (distributed multi-node system).

Referring to FIG. 4, the process for transmitting and receiving data between a base station and a user equipment in a DMNS mainly consists of such a repetitive process as (1) antenna node assignment according to UE [S402], (2) resource allocation to the assigned antenna node according to a user [S402], and (3) delivery of a data and control information [S403].

The antenna node assignment according to UE, which is the process of the (1), consists of 1) a step of obtaining channel information according to an antenna node of a user equipment [S401-1] and a step of delivering information on antenna node assignment from the base station to the user equipment [S401-2].

And, according to the (2) process, the base station performs a resource allocation according to the antenna node selected for each user equipment in a manner of performing the resource allocation according to a user for the antenna node assigned to the user equipment [S402]. In this case, the selected antenna node can be independent from each other between UEs (i.e., SU-MIMO based) or can be shared by the UEs (i.e., MU-MIMO based).

And, according to the (3) process, the base station transmits a scheduled data to the user equipment in downlink [S403].

In this case, the base station may be able to transmit a midamble and the like to the user equipment to enable the user equipment to measure a downlink channel.

In this case, if the number of antenna node capable of being transmitted in one midamble time is greater than the number of valid antenna node, the base station may be able to transmit the midamble to the user equipment in a manner of expanding to a time domain.

As an example, m^{th} subframe-antenna node (m−1)P_{midable}˜mP_{midamble}

In this case, 1≦m≦M, M=P_{efj}^{l}P_{midamble}. P_{efj} indicates the number of valid antenna node and Pmidamble indicates the maximum number of antenna node in one midamble symbol.

Thereafter, the user equipment feedbacks the control information calculated by a downlink channel estimation to the base station.

FIG. 5 is an internal block diagram of a user equipment and a base station according to one embodiment of the present specification. The base station 810 includes a control unit 811, a memory 812, and a radio frequency (RF) unit 813. The control unit 811 implements the proposed functions, processes and/or methods. Layers of a radio interface protocol can be implemented by the control unit 811. The control unit 811 is configured to perform an operation according to the embodiment disclosed in the present specification illustrated with reference to the accompanying drawings.

The memory 812 is connected to the control unit 811 and then stores a protocol or a parameter for managing a distributed multi-node system.

The RF unit 813 is connected to a control unit 811 and then transmits and/or receives a radio signal. The user equipment 820 includes a control unit 821, a memory 822, and a radio frequency (RF) unit 823.

The control unit 821 implements the proposed functions, processes and/or methods. Layers of a radio interface protocol can be implemented by the control unit 821. The control unit 821 is configured to perform an operation according to the embodiment disclosed in the present specification illustrated with reference to the accompanying drawings.

The memory 822 is connected to the control unit 821 and then stores a protocol or a parameter for managing a distributed multi-node system. The RF unit 823 is connected to a control unit 821 and then transmits and/or receives a radio signal.

The control unit 811/821 may include ASIC (application-specific integrated circuit), a different chip set, a logical circuit and/or a data processing device. The memory 812/822 may include ROM (read-only memory), RAM (random access memory), a flash memory, a memory card, a storing media and/or a different storing device. The RF unit 813/823 may include a base band circuit to process a radio signal. The aforementioned scheme can be implemented by a module (process, function and the like) performing the above mentioned function when embodiments are implemented by software. The module is stored in the memory 812/822 and may be implemented by the control unit 811/821. The memory 812/822 may be built-in or outside of the control unit 811/821. And, the memory 812/822 may be connected to the control unit 811/821 via various kinds of well-known means.

While the present invention has been described and illustrated herein with reference to the preferred embodiments thereof, it will be apparent to those skilled in the art that various modifications and variations can be made therein without departing from the spirit and scope of the invention. Thus, it is intended that the present invention covers the modifications and variations of this invention that come within the scope of the appended claims and their equivalents. And, it is apparently understandable that an embodiment is configured by combining claims failing to have relation of explicit citation in the appended claims together or can be included as new claims by amendment after filing an application.

What is claimed is:

1. A method of transmitting a reference signal (RS) in a distributed multi-node system, comprising the steps of:
constructing multiple channel state information reference signals (CSI-RSs) having power which is not zero in an intra-cell for the distributed multi-node system;
transmitting a control information on the multiple channel state information reference signals (CSI-RSs), which is transmitted by a base station, to a user equipment (UE); and
receiving a feedback information on at least one of the channel state information reference signal from the UE,
wherein the channel state information reference signal of multiple patterns is transmitted in one subframe.

2. The method of claim 1, wherein the channel state information reference signals of multiple patterns are transmitted throughout many subframes.

3. The method of claim 1 or claim 2, wherein the channel state information reference signals of multiple patterns comprise a predetermined duty cycle according to each pattern or according to the multiple patterns and wherein the channel state information reference signal in each subframe among the many subframes comprises a predetermined offset interval.

4. The method of claim 1, wherein at least one of the multiple channel state information reference signals is UE-dedicated or UE-specific.

5. The method of claim 1, wherein at least one of the multiple channel state information reference signals is cell-specific or UE-common.

6. The method of claim 1, wherein the control information comprises a CSI-RS type indication information indicating whether the CSI-RS is for a channel state information (CSI) feedback or a node selection feedback.

7. The method of claim 4, wherein a feedback information on the node selection comprises at least one of RSSI, RSRP, or RSRQ measured for the CSI-RS.

8. The method of claim 1, wherein each of the CSI-RSs consists of each sequence and wherein the each sequence is distinguished by a node index, a port number, or a virtual cell ID.

9. The method of claim 8, wherein the sequence of each CSI-RS is generated in a manner of using a value delivered via a message of an upper layer instead of a physical cell identity.

10. The method of claim 8, wherein the virtual cell ID consists of integers greater than or equal to 0 and less than or equal to 503.

11. The method of claim 1, wherein the control information further comprises information on the maximum number of the CSI-RS capable of being included in one subframe.

12. The method of claim 1, wherein the intra-cell corresponds to one cell containing one physical cell identity or physical layer cell identity.

13. A method of receiving a reference signal (RS) in a distributed multi-node system, comprising the steps of:
receiving a control information on a channel state information reference signal (CSI-RS) having power which is not zero from a base station,
receiving at least one of the channel state information reference signal from at least one antenna node in an intra-cell based on the control information; and
transmitting a feedback information on the at least one of the channel state information reference signal,
wherein the control information comprises information that the channel state information reference signal (CSI-RS) consists of multiple patterns for the distributed multi-node system and wherein the channel state information reference signal of multiple patterns is received in at least one subframe.

14. The method of claim 13, wherein the channel state information reference signal of multiple patterns is transmitted throughout many subframes.

15. The method of claim 13 or claim 14, wherein the channel state information reference signals of multiple patterns comprise a predetermined duty cycle according to each pattern or according to the multiple patterns and wherein the channel state information reference signal in each subframe among the many subframes comprises a predetermined offset interval.

16. The method of claim 13, wherein the feedback information comprises the feedback information on a channel state information (CSI) or the feedback information on a node.

17. The method of claim 16, wherein the feedback information on the node comprises at least one of RSSI, RSRP, or RSRQ.

18. The method of claim 16, wherein a CSI-RS type indication information indicating whether the CSI-RS is for a feedback on the channel state information or the feedback on the node is received from the base station.

19. The method of claim 16, wherein each node is distinguished by a node distinction information of a CSI-RS sequence and wherein the node distinction information corresponds to a node index, a port number, or a virtual cell ID.

20. The method of claim 19, wherein the virtual cell ID consists of integers greater than or equal to 0 and less than or equal to 503.

21. The method of claim 16, wherein the channel state information or the node information is feedback on each of the at least one CSI-RS pattern or feedback on a combination of the at least one CSI-RS patterns.

22. The method of claim 13, wherein the control information further comprises information on the maximum number of the CSI-RS capable of being included in one subframe.

23. The method of claim 13, wherein the control information further comprises a UE-specific CSI-RS pattern mapping information.

24. A transmission station transmitting a reference signal (RS) in a distributed multi-node system, comprising:
a control unit configured to construct multiple channel state information reference signals (CSI-RSs) having power which is not zero in an intra-cell; and
a transmission/reception unit configured to transmit control information on the multiple channel state information reference signals (CSI-RSs) to a user equipment (UE) according to a control of the control unit,
wherein the channel state information reference signal of multiple patterns is transmitted in one subframe or throughout many subframes and wherein the transmission/reception unit is configured to receive a feedback information on at least one of the channel state information reference signal from the user equipment.

25. A user equipment receiving a reference signal (RS) in a distributed multi-node system, comprising:
a control unit;
a reception unit configured to receive control information on the multiple channel state information reference signals (CSI-RSs) having power which is not zero from a base station according to a control of the control unit; and
a transmission unit configured to transmit a feedback information on at least one of the channel state information reference signal according to a control of the control unit,
wherein the control information comprises information on multiple pattern configurations for the channel state information reference signal (CSI-RS), wherein the reception unit configured to receive channel state information reference signal from at least one antenna node in an intra-cell based on the control information, and wherein the channel state information of multiple patterns is received in one subframe or throughout many subframes.
